(19) United States
(12) Patent Application Publication
(10) Pub. No.: US 2008/0025392 A1
(43) Pub. Date: Jan. 31, 2008

(54) Method and apparatus for controlling video encoding data rate

(75) Inventors: Chang-Hyun Lee, Seoul (KR); Jae-Seok Kim, Seoul (KR); Seong-Joo Lee, Seoul (KR); Yun-Je Oh, Yongin-si (KR); Young-Hun Joo, Yongin-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/880,969

(22) Filed: Jul. 25, 2007

(30) Foreign Application Priority Data
Jul. 27, 2006 (KR) 70856/2006

(51) Int. Cl. H04N 7/26

(52) U.S. Cl. 375/240.03; 375/E07.14

(57) ABSTRACT

A method and apparatus for controlling a video encoding data rate in real-time in order to minimize performance deterioration, even when a scene change has occurred in an application field having a small number of available bits due to a low bit rate and a high frame rate. The method includes: a first step of determining whether scene change has occurred in a current frame; a second step of determining whether a number of current available bits is more than a preset reference when it is determined that the scene change has occurred; and a third step of adjusting a Quantization Parameter (QP) according to a first preset condition when it is determined that the number of current available bits is more than that preset reference. An apparatus includes an encoder QP controller having a QP module for adjusting the QP.

### CLAIM OF PRIORITY

This application claims priority from an application entitled “Method For Controlling Video Encoding Data Rate,” filed in the Korean Intellectual Property Office on Jul. 27, 2006 and assigned Serial No. 2006-70856, the contents of which are hereby incorporated by reference in its entirety.

### BACKGROUND OF THE INVENTION

1. Field of the Invention

The present invention relates to video encoding in scene changes. More particularly, the present invention relates to a method for controlling a video encoding data rate having particular applicability in environments having both a low bit rate and a high frame rate.

2. Description of the Related Art

Various digital video compression technologies have been proposed in order to obtain a low data rate, or for a smaller storage region maintaining high image quality when a video signal is transmitted or stored. Such video compression technology is disclosed in a number of international standards, such as H.261, H.263, H264, MPEG-2, MPEG-4, etc. These compression technologies can provide a comparatively high compression rate by using a method of discrete cosine transform (DCT) or by using a method of a motion compensation (MC), etc. The various video compression technologies can be applied to attempt to transfer data efficiently to any digital network which has various streams of the video data, such as, for example, a mobile terminal network, a computer network, a cable network, a satellite network, etc. Moreover, video compression technology in general can be applied to efficiently transfer to a memory media, such as a hard disk, an optical disk, and a digital video disk (DVD), etc.

In order to obtain high-quality images, a large amount of data is required in the video encoding. Recent advances in areas such as High Definition broadcasts only increases the demand for transfer of high quality images over available bandwidth. However, a communication network by which the video data is transferred may limit the data rate applied to the encoding to a constant value. For example, typically a data channel of a satellite broadcasting system or a data channel of a digital cable television network normally transfers the data with a constant bit rate in part because of difficulty involved with receiving transfers with a plurality of bit rates. Also, the storage capacity of the storage media such as a disk has a defined value for storage, particularly when storage is being utilized in a buffer capacity.

Therefore, a video encoding process normally compromises some of its capability in that typically there is an alternative trade off regarding the number of bits required to attain the desired image quality and the image compression. Also, video encoding requires a number of relatively complex processes and lots of CPU cycles comparatively in operation by using software. Furthermore, there is a problem when video encoding is processed and reproduced in real time, as the time condition limits the accuracy in operation of the encoding, and thereby the quality of the video is restricted.

As described above, the data rate control of video encoding is an important factor, particular in a real time environment, and the data rate control of the video encoding is set to obtain high image quality reducing the complexity of the processing method and data rate of transmitting.

In recent times, an H.264/AVC (Advanced Video Coding) is a video codec having the best performance. The data rate control of an H.264/AVC conforms to a scheme proposed by an JVT (Joint Video Team: ITU-T Video Coding Experts Group and ISO/IEC 14496-10 AVC Moving Picture Experts Group, Z. G. Li. F. Pan, K. P. Lim, G. Feng, X. Lin, and S. Rahardja, “Adaptive basic unit layer rate control for JVT”, JVT-G012-r1, 7^{th} Meeting Pattaya II, Thailand, March 2003.), which is hereby incorporated by reference as background material. The JVT discloses basic technology for controlling a data rate by adjusting a Quantization Parameter (QP) in video frame encoding.

According to the Rate Distortion Optimization (RDO) of an H.264/AVC, an intra mode is selected according to macroblocks in an interframe. In general, an inter coding mode refers to a process whereby a macroblock in a current frame is predicted and displaced from a block in a previous frame. The difference between the block in the current frame and its prediction is compressed and transmitted along with displacement vectors. One way that an intra mode works is that the macroblocks are DCT transformed and quantized. A quantized coefficient is obtained and a coded block pattern is produced based on the quantized coefficient. Specifically, in the case of a video frame having no similarity with a previous frame as with scene change, an intra mode is selected in most macroblocks even though a corresponding frame is an interframe. If scene change occurs in an interframe, video quality cannot be prevented from deteriorating before using many more bits than those estimated by encoding data rate control. That is, if scene change is not considered in encoding data rate control, serious performance deterioration may occur.

Accordingly, in most video encoding data rate control schemes created prior to the H.264/AVC, many bits are assigned to a frame in which a scene change has occurred, thereby preventing performance deterioration such as video quality deterioration.

However, in an application field having a small number of available bits per frame due to a low bit rate and a high frame rate, significant problems may occur when the video encoding data rate control is performed by the afore-described scheme. In other words, in such an application field, if many bits are assigned to a corresponding frame when scene change has occurred, it is impossible to avoid performance deterioration in remaining frames.

### SUMMARY OF THE INVENTION

Accordingly, the present invention has been made to solve in part at least some of the above-mentioned problems occurring in the prior art. Moreover, the present invention provides a method for controlling a video encoding data rate in real time in order to minimize performance deterioration, even when a scene change has occurred in an application field having a small number of available bits due to a low bit rate and a high frame rate.

In accordance with an aspect of the present invention, there is provided a method for controlling a video encoding data rate, the method including: determining whether a scene change has occurred in a current frame; determining whether a number of current available bits is more than a preset reference when a scene change has occurred; and adjusting a Quantization Parameter (QP) according to a first preset condition when it is determined that the number of current available bits is more than that of a preset reference value.

### BRIEF DESCRIPTION OF THE DRAWINGS

The above and other aspects, features and advantages of the present invention will be more apparent from the following detailed description taken in conjunction with the accompanying drawings, in which:

FIG. 1 is a block diagram of a video encoder device to which the present invention is applied;

FIG. 2 is a flow diagram illustrating a general video encoding data rate control operation; and

FIG. 3 is a flow diagram illustrating a video encoding data rate control operation according to one embodiment of the present invention.

### DETAILED DESCRIPTION OF THE INVENTION

Exemplary embodiments of the present invention will be described in detail herein below with reference to the accompanying drawings. It is to be understood that the examples shown and described have been provided for purposes of illustration and not to limit the invention to the exemplary embodiments herein. Particular items, such as detailed elements, are shown, but these items are provided for aiding the general understanding of the present invention, and it will be understood by those skilled in the art that such particular items can be modified within the scope of the present invention.

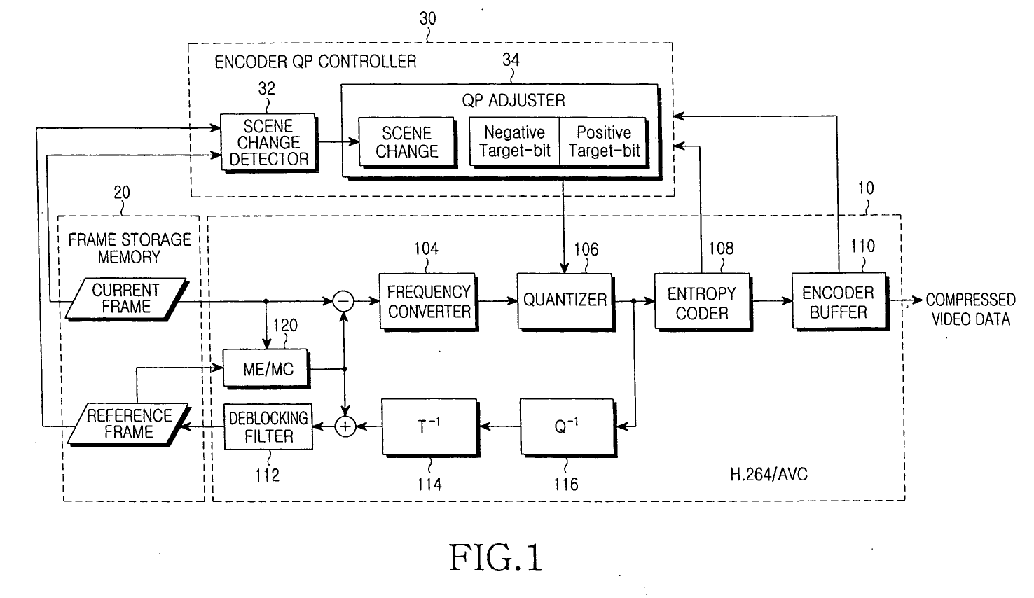

FIG. 1 is a block diagram of a video encoder device according to the present invention. Referring to FIG. 1, the video encoder device can include a general H.264/AVC encoder 10 for receiving video frame sequences and outputting compressed video data. Further, the video encoder device includes a frame storage memory 20 for storing frames, and an encoder QP controller 30 for performing a QP control operation for the data rate control of the encoder 10.

First, the construction and operation of the video encoder 10 will be described in more detail. The video encoder 10 includes a frequency converter 104, a quantizer 106, an entropy coder 108, an encoder buffer 110, an inverse quantizer 116, an inverse-frequency converter 114, a Motion Estimator (ME)/Motion Compensator (MC) 120, and a deblocking filter 112.

Still referring to FIG. 1, if a current frame is an interframe (i.e. P frame), the ME/MC 120 estimates and compensates for motion of a macroblock within the current frame with a reference frame which is a frame obtained by restructuring a previous frame buffered in the frame storage memory 20. For example, a frame is processed by the macroblock corresponding to 16×16 pixels of the original video. Each macroblock is encoded in an intra mode or an inter mode. In motion estimation, motion information, such as motion vectors, is output as supplementary information. In motion compensation, a motion-compensated current frame is generated by applying the motion information to the previous frame for which restructuring has been performed. Then, a difference between the macroblock (estimation macroblock) of the motion-compensated current frame and the macroblock of the original frame is provided to the frequency converter 104. By providing the difference rather than each entire macroblock, the amount of data transmitted is reduced.

The frequency converter 104, which receives the difference information, converts a spatial domain of video information into frequency domain data (i.e. spectrum data). Herein, the frequency converter 104 typically performs Discrete Cosine Transform (DCT) to generate DCT coefficient blocks by the macroblock.

Still referring to FIG. 1, the quantizer 106 quantizes blocks of spectrum data coefficients output from the frequency converter 104. Herein, the quantizer 106 applies predetermined scalar quantization to the spectrum data according to the step-size changed based on frames. The quantizer 106 receives variable information of the QP from the QP adjuster 34 of an encoder QP controller 30 according to frames for data rate control.

The entropy coder 108 compresses the output from the quantizer 106, as well as specific supplementary information (i.e. motion information, spatial extrapolation, quantization parameter), of a corresponding macroblock. Generally applied entropy coding technology includes arithmetic coding, Huffman coding, run-length coding, and Lempel Ziv (LZ). The entropy coder 108 typically applies different coding technologies to different types of information.

The video information compressed by the entropy coder 108 is buffered by the encoder buffer 110. The buffer level indicator of the encoder buffer 110 is provided to the encoder QP controller 30 for data rate control. For example, the video information stored in the encoder buffer 110 is output or deleted from the encoder buffer 110 at a fixed data rate.

When the current frame is restructured as described above as being necessary for subsequent motion estimation/compensation, the inverse quantizer 116 performs inverse quantization for quantized spectrum coefficients. The inverse-frequency converter 114 performs an operation inverse to that of the frequency converter 104, thereby generating an inverse difference macroblock through inverse DCT conversion from the output of the inverse quantizer 116. The inverse-difference macroblock is not identical to the original difference macroblock due to influence of signal loss, etc.

When the current frame is an interframe, the restructured inverse-difference macroblock is mixed with the estimation macroblock of the ME/MC 120 so as to generate restructured macroblocks. The restructured macroblocks are stored in the frame storage memory 20 as reference frames in order to be used for estimation of a subsequent frame. Herein, since the restructured macroblock corresponds to a distorted version of the original macroblock, a deblocking filter 112 is applied to the restructured frame for compensation of discontinuity between macroblocks in some embodiments.

In the meantime, the encoder QP controller 30, which controls the QP of the encoder 10, includes a scene change detector 32 for detecting scene change in real time through the current frame, the reference frame, etc., stored in the frame storage memory 20 according to the characteristics of the present invention. If the scene change detector 32 detects a scene change, this detection information is provided to the QP adjuster 34. Accordingly, the QP adjuster 34 properly adjusts the QP of the quantizer 106 in the detection of the scene change, and copes with the scene change of the current frame.

With regard to the detection of the scene change, the scene change detector 32 uses correlation, statistical sequential analysis, histogram(s), etc., in order to obtain similarity between adjacent frames. Further, the scene change detector 32 may also detect scene change by using error information of samples (pixels) between the current frame and the reference frame. One example of scene change detection technology using a histogram has been disclosed in Patent Application No. 2002-39579 (Title: scene change detector and method using the same, Inventor: Moon-Chul Kim, Filing date: Jul. 9, 2002) filed by the applicant of the present invention, and incorporated by reference in its entirety as background material.

The QP adjuster 34 basically estimates the number of target bits to be compressed according to the current frames of a group of pictures (GOP) based on current transmission environments, and properly adjusts a QP. The target bit estimation and QP adjustment scheme may be similar to that disclosed in the JVT (Joint Video Team: ITU-T Video Coding Experts Group and ISO/IEC 14496-10 AVC Moving Picture Experts Group). However, according to the present invention, the QP adjuster 34 includes a program module for processing operations relating to scene change detection according to the characteristics of the present invention, as well as a program module for performing operations when a target bit is a negative number or a positive number.

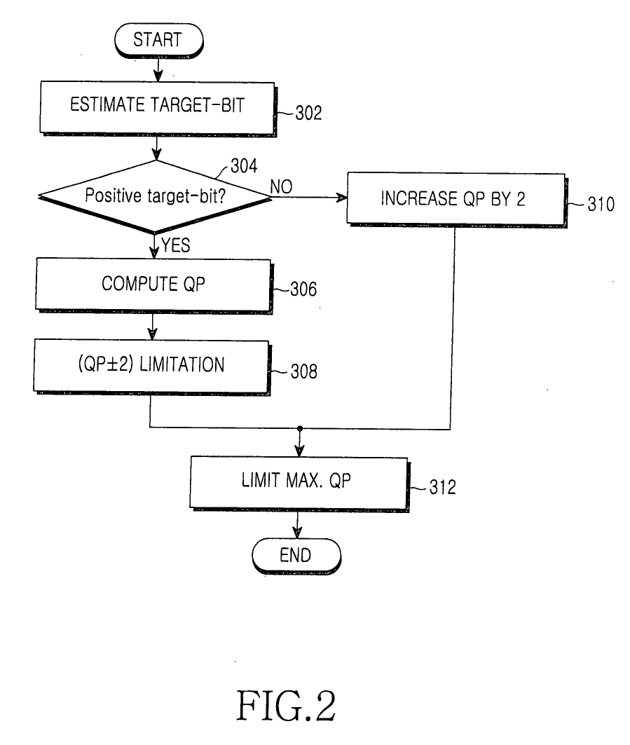

FIG. 2 is a flow diagram illustrating a general video encoding data rate control operation disclosed in the JVT. Hereinafter, the general video encoding data rate control operation will be described with reference to FIG. 2. In step 302, the target bit of a corresponding frame is estimated. The target bit T_{b,i} of an i^{th} frame may be computed by Equation (1) below.

$${T}_{b , i} = β \frac{{R}_{b , i}}{{N}_{Pr , i}} + ( 1 - β ) [ \frac{{b}_{r}}{{f}_{r}} - Γ ( {CBF}_{i - 1} - {TBL}_{i} ) ] \qquad ( 1 )$$

In Equation (1), N_{Pr,i} denotes the number of unencoded P frames before the i^{th} frame is encoded, and β & Γ are constants (generally, 0.5 and 0.75 respectively). bᵣ denotes a preset bit rate [bit/sec] and the fᵣ denotes a preset frame rate [frame/sec]. For the Current Buffer Fullness (CBF) and the Target Buffer Level (TBL), CBFᵢ denotes a state value filled in a buffer after the i^{th} frame is coded, and TBLᵢ denotes the target buffer level of the i^{th} frame.

The R_{b,i} is equal to Equation (2) below.

$${R}_{b , i} = \{ \begin{matrix}( {N}_{P} + 1 ) \times {b}_{r} / {f}_{r} & i = 1 \\ {R}_{b , i - 1} + [ ( {N}_{P} + 2 - i ) ( {b}_{r , i} - {b}_{r , i - 1} ) / {f}_{r} ] - {G}_{b , i - 1} & i - 2 , 3 , … , {N}_{P} + 1\end{matrix} \qquad ( 2 )$$

In Equation (2), N_{P} denotes the total number of P frames of a corresponding GOP, and b_{r,i} & the G_{b,i} denote an available channel bandwidth and bits generated in the i^{th} frame, respectively.

In other words, in step 302, the target bit T_{b,i} of the i^{th} frame is estimated as expressed by Equations 1 and 2, and then a QP is computed. When the target bit is estimated as described above, a corresponding computation value is a positive number in a relatively normal state. However, if the value of the CBF significantly increases among the variables of Equation 1 (i.e. if a buffer is filled more than a certain level), a corresponding target bit value becomes a negative number. When the value obtained by estimating the target bit is a negative number as described above, it is regarded as an abnormal state.

In step 304, it is determined whether the target bit estimated in step 302 is a positive number. When the estimated target bit is determined to be a positive number, step 306 is performed. Otherwise, step 310 is performed. In step 306, a Quantization Parameter (QP) is computed according to the estimation value of the corresponding target bit. In step 308, the QP computed in step 306 is compared with a previous QP so as to cause the increment and decrement from the comparison result to belong to a preset range, e.g. −2 to +2. In step 312, the currently increased QP is prevented from exceeding a preset maximum allowable value, e.g. 51.

However, when the estimated target bit is a negative number in step 304, the QP is unconditionally increased by a preset value (e.g. 2) in step 310. Then, step 312 is performed. As described above, the QP is increased or decreased, thereby decreasing or increasing the total number of bits of a corresponding frame.

While the target bit estimation and QP adjustment scheme may be equal to that disclosed in the JVT, but the JVT has not considered the scene change of a video. In particular, at one difference from the JVT is that if it is estimated that a scene change will occur in an interframe within the same GOP, the present invention operates as expressed by Equation (3) below, instead of conforming to the general video encoding data rate control scheme.

$${Q}_{i} = \{ \begin{matrix}MAX \{ {Q}_{i - 1} + 4 , {Q}_{0} \} & ( {b}_{r} / {f}_{r} ) < 400 \\ MIN \{ {Q}_{0} , {Q}_{i - 1} + 4 \} & elsewhere\end{matrix} \qquad ( 3 )$$

In Equation (3), the variables are defined as follows.
Qᵢ: QP of the i^{th} frame
Q₀: QP of an initial intra and inter frame
bᵣ: target bit rate
fᵣ: target frame rate

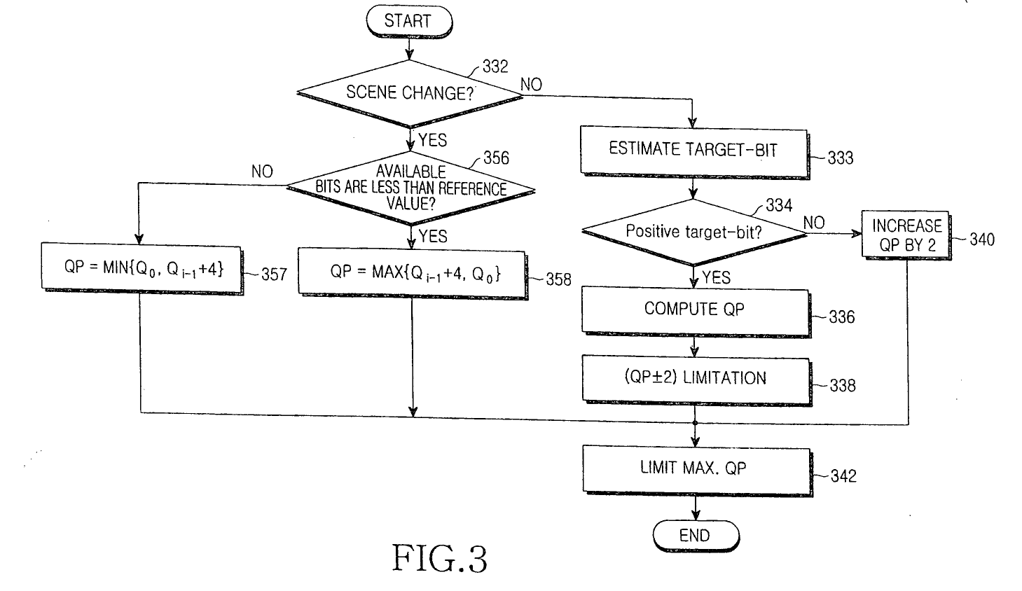

Moreover, according to the present invention, f it is estimated that a scene change will occur in a corresponding frame, the a quantity of the current available bits (bᵣ/fᵣ) is determined. For example, when it is determined that the current available amount of bits is less than 400, the QP is selected as a large value between the [previous QP+4] and the Q₀. In other cases, the QP is selected as a small value between the Q₀ and the [previous QP+4]. Note that the QP is selected as a comparatively larger value between the <previous QP+4> and Q₀. That is to say, the one having the larger value of the above <previous QP+4> and Q₀ is selected. Moreover, as the above expression, the QP is selected as a comparatively smaller value between the <previous QP+4> and Q₀. Hereinafter, such operations will be described in more detail with reference to FIG. 3.

FIG. 3 is a flow diagram illustrating a video encoding data rate control operation according to an exemplary embodiment of the present invention.

Referring to FIG. 3, at step 332, the scene change detector will determine whether a scene change has occurred in a current frame or whether it is estimated that scene change will occur in a current frame is determined. As previously disclosed, there are a number of ways that the scene change detector makes such a determination, including but not limited to the use of correlation, statistical sequential analysis, histogram(s), etc., in order to obtain similarity between adjacent frames, and/or by using error information of samples (pixels) between the current frame and the reference frame. When the scene change has occurred, step 356 is performed.

At step 356, it is determined whether the current available bits are less than a reference value (e.g. 400). When the current available bits are less than the reference value, step 358 is performed; otherwise, step 357 is performed.

With regard to step 358, typically, as discussed above, the QP adjuster includes a program module for processing operations relating to scene change detection according to the characteristics of the present invention, as well as a program module for performing operations when a target bit is a negative number or a positive number. In addition, a QP is selected as a large value between [previous QP+4] and an initial QP(Q₀).

Referring back to step 357, when the available bits are less than the reference value, a QP is selected as a small value between the Q₀ and the [previous QP+4]. In step 342 after steps 357 and 358, the currently increased QP is prevented from exceeding a preset maximum allowable value, e.g. 51.

Referring back to step 332, when the scene change has not occurred in the current frame, step 333 is performed similarly to the operation illustrated in FIG. 2. In other words, in step 333, the target bit of a corresponding frame is estimated, and the target bit T_{b,i} of an i^{th} frame is computed by Equation 1. In step 334, it is determined whether the estimated target bit is a positive number. When the estimated target bit is a positive number, step 336 is performed. However, when the estimated target bit is a negative number, step 340 is performed.

With regard to step 336, a QP is computed according to the estimated value of a corresponding target bit. In step 338, the QP computed in step 336 is compared with a previous QP, and the increment and decrement from the comparison result is limited within the range of −2 to +2. Then, step 342 is performed.

With regard to step 340, the QP is unconditionally increased by 2 from the previous QP. Then, step 342 is performed.

In order to consider the encoding data rate control scheme according to the present invention as described above, random test sequence videos, so called ‘MissAmerica+Carphone’ and ‘Akiyo+Container’, are respectively connected by 50 frames, thereby generating a new video. Accordingly, in the new video, scene change occurs in each 50^{th} frame. Then, the JVT is compared with the results from the scheme according to the present invention in consideration of Peak Signal to Noise Ratios (PSNRs) as shown in Table 1 below.

TABLE 1

| | | | | Standard | | | |
|---|---|---|---|---|---|---|---|
| | | Average Y-PSNR | | Deviation of | | Encoded Bit rate | |
| | Target | [dB] | | Y-PSNR | | [kbps] | |
| Sequence | bit rate | JVT¹ | Proposed | JVT¹ | Proposed | JVT¹ | Proposed |
| MA_Carphone | 19.2 kbps | 34.768 | 35.688 | 6.227 | 5.237 | 19.32 | 19.20 |
| Akiyo_Container | 38.4 kbps | 39.403 | 39.813 | 5.423 | 4.810 | 38.28 | 38.50 |

As shown in Table 1, according to the video encoding data rate control method based on the present invention, video quality for a video having scene change has been improved by 0.4 to 0.9 dB, change in video quality per frame has decreased, a bit rate difference between a target bit rate and an encoding bit rate has decreased in comparison with the JVT. Further, the buffer level has been stable in comparison with the JVT method.

According to the video encoding data rate control scheme of the present invention as described above, even when scene change occurs in an application field having a small number of available bits per frame due to a low bit rate and a high frame rate, it is possible to minimize performance deterioration.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be rendered in such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

While the present invention has been shown and described with reference to certain exemplary embodiments thereof, it will be understood by those skilled in the art that various changes in form and details may be made therein without departing from the spirit and scope of the present invention as defined by the appended claims.

What is claimed is:

1. A method for controlling a video encoding data rate, the method comprising the steps of:
(a) determining whether a scene change has occurred in a current frame;
(b) determining whether a number of current available bits is more than a preset reference when it is determined that the scene change has occurred; and
(c) adjusting a Quantization Parameter (QP) according to a first preset condition when it is determined that the number of current available bits is more than that preset reference.

2. The method according to claim 1, wherein the scene change in step (a) is determined by performing one or more of correlation, statistical sequential analysis, histogram(s), in order to obtain similarity between adjacent frames, and/or by using error information of samples (pixels) between the current frame and a reference frame.

3. The method according to claim 1, where the QP parameter is adjusted in step (c) by estimating a number of target bits to be compressed according to the current frames of a group of pictures (GOP) based on current transmission environment, and when a target bit value is a positive number, computing the QP parameter, whereas when the target bit value is a negative number, incrementing the QP parameter by a preset value until the target bit value becomes a positive number.

4. The method as claimed in claim 1, wherein, in step (c), the QP is selected as a smaller value between a [previous QP+4] and an initial QP.

5. The method according to claim 1, further comprising a step of (d) adjusting the QP according to a second preset condition when it is determined that the number of current available bits is less than the preset reference.

6. The method according to claim 5, wherein, in step (d), the QP is selected as a larger value between a [previous QP+4] and an initial QP.

7. The method according to claim 5, further comprising a step of (e) preventing the adjusted QP from exceeding a preset maximum allowable value.

8. The method according to claim 1, further comprising a step of preventing the adjusted QP from exceeding a preset maximum allowable value.

9. A method for controlling a video encoding data rate, the method comprising:
(a) determining whether a scene change has occurred in a current frame;
(b) determining whether a number of current available bits is more than a preset reference when it is determined that the scene change has occurred;
(c) adjusting a Quantization Parameter (QP) according to a first preset condition or a second preset condition according to determination results in step (b);
(d) estimating a target bit of a current frame when it is determined that the scene change has not occurred;
(e) computing a QP according to the estimated target bit;
(f) comparing the QP computed in step (e) with a previous QP, thereby controlling the QP to belong to a preset range; and
(g) preventing the QP adjusted in steps (d) and (f) from exceeding a preset maximum allowable value.

10. The method according to claim 9, wherein, in step (c), the QP is selected as a smaller value between a [previous QP+4] and an initial QP.

11. The method according to claim 9, wherein, in step (c), the QP is selected as a larger value between a [previous QP+4] and an initial QP.

12. The method according to claim 9, wherein step (e) comprises the steps of:
computing the QP according to estimated values of the corresponding target bit when the estimated target bit is a positive number; and
increasing the previous QP by a preset increment to adjust the QP when the estimated target bit is a negative number.

13. The method according to claim 10, wherein step (e) comprises the steps of:
computing the QP according to estimated values of the corresponding target bit when the estimated target bit is a positive number; and
increasing the previous QP by a preset increment to adjust the QP when the estimated target bit is a negative number.

14. The method according to claim 11, wherein step (e) comprises the steps of:
computing the QP according to estimated values of the corresponding target bit when the estimated target bit is a positive number; and
increasing the previous QP by a preset increment to adjust the QP when the estimated target bit is a negative number.

15. An apparatus for controlling a video encoding data rate, comprising:
an encoder for receiving video frame sequences and outputting compressed video data;
a frame storage memory in communication with said encoder for storing video frame sequences, and
an encoder Quantization Parameter (QP) controller for performing a QP control operation for the data rate control of the encoder;
wherein the QP controller includes a module for:
(a) determining whether a scene change has occurred in a current frame;
(b) determining whether a number of current available bits is more than a preset reference when it is determined that the scene change has occurred; and
(c) adjusting a Quantization Parameter (QP) according to a first preset condition or a second preset condition according to determination results in step (b).

16. The apparatus according to claim 15, wherein the module in said QP controller further performs:
(d) estimating a target bit of a current frame when it is determined that the scene change has not occurred;
(e) computing a QP according to the estimated target bit;
(f) comparing the QP computed in step (e) with a previous QP, thereby controlling the QP to belong to a preset range; and
(g) preventing the QP adjusted in the steps (d) and (f) from exceeding a preset maximum allowable value.

17. The apparatus according to claim 16, wherein the module in said QP controller computes the QP according to the estimated target bit by:
computing the QP according to estimated values of the corresponding target bit when the estimated target bit is a positive number; and
increasing the previous QP by a preset increment to adjust the QP when the estimated target bit is a negative number

18. The apparatus according to claim 17, wherein the module in said QP controller estimates that a scene change will occur further comprises that when a scene change is estimated in an interframe within the same group of pictures (GOP), the encoding data rate control scheme in the encoder operates in accordance with the following equation:
$${Q}_{i} = \{ \begin{matrix}MAX \{ {Q}_{i - 1} + 4 , {Q}_{0} \} & ( {b}_{r} / {f}_{r} ) < 400 \\ MIN \{ {Q}_{0} , {Q}_{i - 1} + 4 \} & elsewhere\end{matrix} \qquad ( 3 )$$
wherein:
Qᵢ: QP of the i^{th} frame
Q₀: QP of an initial intra and inter frame
bᵣ: target bit rate
fᵣ: target frame rate.

19. The apparatus according to claim 16, wherein the QP controller includes another module for performing operations when a target bit is a negative number or a positive number.
